(19) United States
(12) Patent Application Publication
(10) Pub. No.: US 2018/0285775 A1
(43) Pub. Date: Oct. 4, 2018

(54) SYSTEMS AND METHODS FOR MACHINE LEARNING CLASSIFIERS FOR SUPPORT-BASED GROUP

(71) Applicant: salesforce.com, inc., San Francisco, CA (US)

(72) Inventor: Philip Bergen, Haiku, HI (US)

(73) Assignee: salesforce.com, inc., San Francisco, CA (US)

(21) Appl. No.: 15/477,400

(22) Filed: Apr. 3, 2017

(51) Int. Cl. G06N 99/00; G06F 17/30

(52) U.S. Cl. CPC G06N 99/005; G06F 17/30864; G06F 17/30312

(57) ABSTRACT

Systems and methods are provided for classifying support-related messages from users in a support-related group. A method includes receiving a support-related message containing a support-related problem. The received support-related message is classified by using a processor-implemented machine learning model to identify a support-related category. The identified support-related category is provided for user display.

### TECHNICAL FIELD

This disclosure relates to computer systems for support-based groups and more particularly to computer systems for support-based groups using machine learning classifiers.

### BACKGROUND

Many organizations are moving toward cloud-based services and infrastructure to provide on-demand services. Many enterprises now use cloud-based computing platforms that allow services and data to be accessed over the Internet (or via other networks). Infrastructure providers of these cloud-based computing platforms offer network-based processing systems that often support multiple enterprises (or tenants) using common computer hardware and data storage. This “cloud” computing model allows applications to be provided over the network “as a service” supplied by the infrastructure provider.

Multi-tenant cloud-based architectures have been developed to improve collaboration, integration, and community-based cooperation between customer tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”).

Traditional forums have focused on providing a meeting place for a virtual community of internal users who share common interest. However, forums can also be used for lowering costs in a business context by providing a cheaper avenue for customer service. Instead of calling into a call center where a human agent takes calls and answers questions, forums can provide a more scalable method where customers can help each other answer their own questions. Users may search for help topics before posting to a forum for help. User searching before posting may provide results that may (or may not) be relevant to the user's technical problem.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram depicting an exemplary embodiment of an on-demand multi-tenant database system.

FIG. 2 is a block diagram depicting user systems within a multi-tenant database network system engaging in an online support community or forum.

FIG. 3 is a block diagram depicting a machine learning classifier processing support requests.

FIG. 4 is a block diagram depicting a support help database configuration involving support help categories.

FIG. 5 is a flow chart depicting an operational scenario involving a machine learning classifier that maps support requests to support help categories.

FIG. 6 is a block diagram depicting machine learning algorithms for classifying support requests.

FIG. 7 is a block diagram depicting a training module for training a machine learning classifier.

FIG. 8 is a flow chart depicting an operational scenario for retraining machine learning models.

FIG. 9 is a flow chart depicting an operational scenario where technical support is automatically provided to users.

### DETAILED DESCRIPTION

The subject matter described herein discloses apparatus, systems, techniques and articles that provide user access to a machine learning classification system, such as for technical support in a support-related group. In some examples, apparatuses, systems, techniques and articles disclosed herein provide a machine learning model that contains categories associated with technical problems resulting from utilization by the users were pre-selected product or service. In some examples, systems and methods disclosed herein the machine learning model is retrained based upon reviews from user systems of categorized support help.

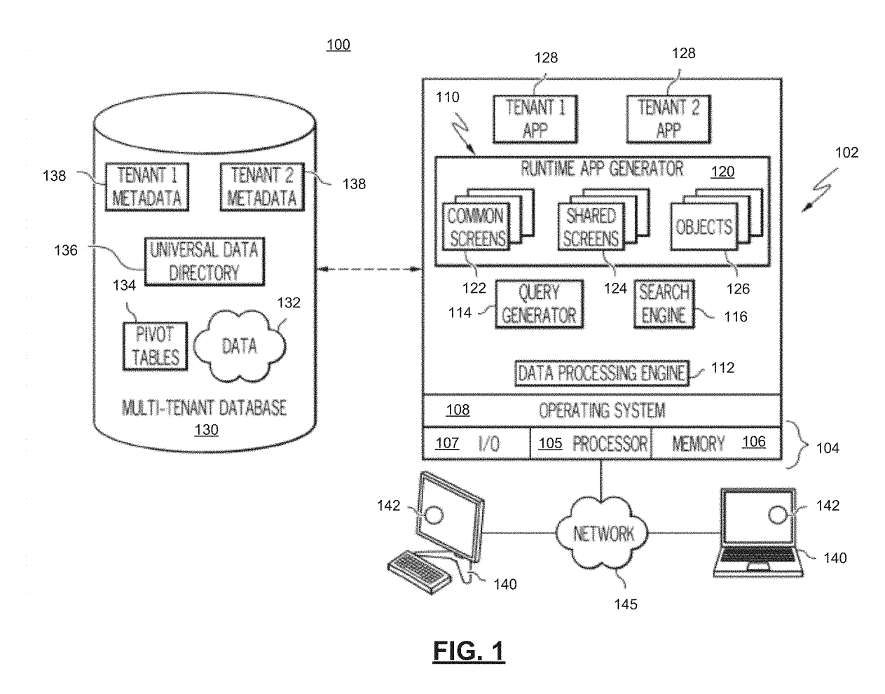

FIG. 1 and the following discussion are intended to provide a brief, general description of one non-limiting example of an example environment in which the embodiments described herein may be implemented. Those of ordinary skill in the art will appreciate that the embodiments described herein may be practiced with other computing environments.

FIG. 1 depicts an exemplary embodiment of an on-demand multi-tenant database system 100. The illustrated multi-tenant system 100 of FIG. 1 includes a server 102 that dynamically creates and supports virtual applications 128 based upon data 132 from a common database 130 that is shared between multiple tenants, alternatively referred to herein as a multi-tenant database. Data and services generated by the virtual applications 128 are provided via a network 145 to any number of client devices 140, as desired. Each virtual application 128 is suitably generated at run-time (or on-demand) using a common application platform 110 that securely provides access to the data 132 in the database 130 for each of the various tenants subscribing to the multi-tenant system 100. In accordance with one non-limiting example, the multi-tenant system 100 is implemented in the form of an on-demand multi-tenant customer relationship management (CRM) system that can support any number of authenticated users of multiple tenants.

As used herein, a “tenant” or an “organization” should be understood as referring to a group of one or more users or entities that shares access to common subset of the data within the multi-tenant database 130. In this regard, each tenant includes one or more users associated with, assigned to, or otherwise belonging to that respective tenant. To put it another way, each respective user within the multi-tenant system 100 is associated with, assigned to, or otherwise belongs to a particular tenant of the plurality of tenants supported by the multi-tenant system 100. Tenants may represent customers, customer departments, business or legal organizations, and/or any other entities that maintain data for particular sets of users within the multi-tenant system 100 (i.e., in the multi-tenant database 130). For example, the application server 102 may be associated with one or more tenants supported by the multi-tenant system 100. Although multiple tenants may share access to the server 102 and the database 130, the particular data and services provided from the server 102 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data 132 belonging to or otherwise associated with other tenants.

The multi-tenant database 130 is any sort of repository or other data storage system capable of storing and managing the data 132 associated with any number of tenants. The database 130 may be implemented using any type of conventional database server hardware. In various embodiments, the database 130 shares processing hardware 104 with the server 102. In other embodiments, the database 130 is implemented using separate physical and/or virtual database server hardware that communicates with the server 102 to perform the various functions described herein. In an exemplary embodiment, the database 130 includes a database management system or other equivalent software capable of determining an optimal query plan for retrieving and providing a particular subset of the data 132 to an instance of virtual application 128 in response to a query initiated or otherwise provided by a virtual application 128. The multi-tenant database 130 may alternatively be referred to herein as an on-demand database, in that the multi-tenant database 130 provides (or is available to provide) data at run-time to on-demand virtual applications 128 generated by the application platform 110.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants. Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 is implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like. The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or application platform, e.g., a portable hard drive, a USB flash drive, an optical disc, or the like.

The application platform 110 is any sort of software application or other data processing engine that generates the virtual applications 128 that provide data and/or services to the client devices 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed in response to input queries initiated or otherwise provided by users of the client devices 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request. In this manner, the query generator 114 suitably obtains requested subsets of data 132 accessible to a user and/or tenant from the database 130 as needed to populate the tables, reports or other features of the particular virtual application 128 for that user and/or tenant.

Still referring to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. For example, a virtual CRM application may utilize standard objects 126 such as “account” objects, “opportunity” objects, “contact” objects, or the like. The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still with reference to FIG. 1, the data and services provided by the server 102 can be retrieved using any sort of personal computer, mobile telephone, tablet or other network-enabled client device 140 on the network 145. In an exemplary embodiment, the client device 140 includes a display device, such as a monitor, screen, or another conventional electronic display capable of graphically presenting data and/or information retrieved from the multi-tenant database 130. Typically, the user operates a conventional browser application or other client program 142 executed by the client device 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. As noted above, the virtual application 128 may contain Java, ActiveX, or other content that can be presented using conventional client software running on the client device 140; other embodiments may simply provide dynamic web or other content that can be presented and viewed by the user, as desired.

A data item, such as a knowledge article, stored by one tenant (e.g., one department in a company) may be relevant to another tenant (e.g., a different department in the same company. One way of providing a user in another tenant domain with access to the article is to store a second instance of the article in the tenant domain of the second tenant. The apparatus, systems, techniques and articles described herein provide another way of providing a user in another tenant domain with access to the article without wasting resources by storing a second copy.

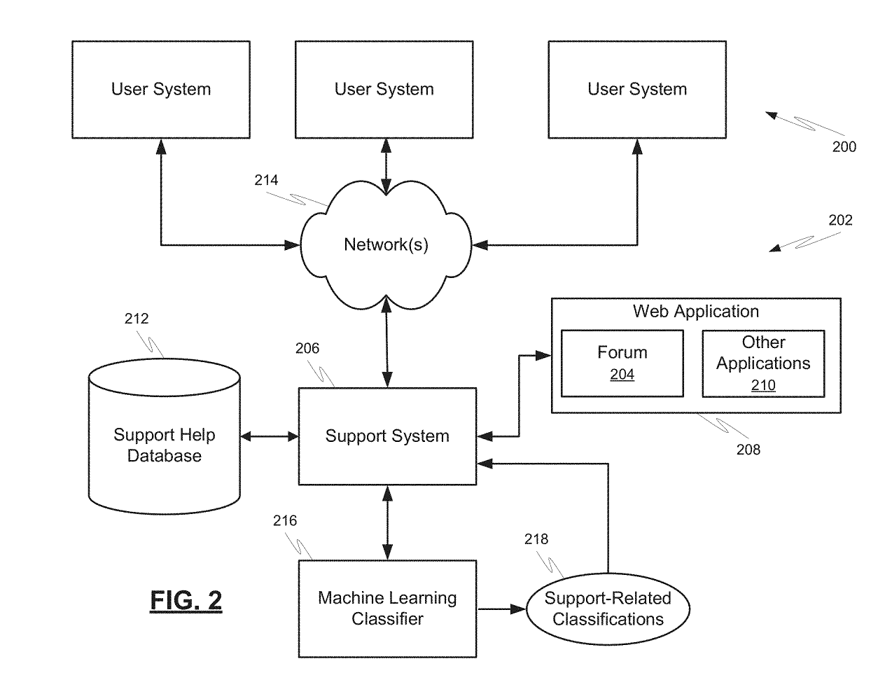

FIG. 2 depicts user systems 200 within a multi-tenant database network system 202 engaging in an online community or forum 204. In this example, the forum 204 operates to support users encountering technical issues arising from different types of situations, such as difficulties in using software products. The forum 204 may be accessible through a server-side support system 206 that operates as a community website where the members can have conversations in the form of posted messages. The members may have a common goal of discussing a product.

In an embodiment, the members of forum 204 may access a web application 208 through the support system 206 in order to register with the forum 204 and login for gaining access to the forum 204. In an embodiment, after the member logs into the forum 204, the member may read the questions that were posted by other members, read the answers to the posted questions by other members, post a question, reply to a question and rate the answers to the question posted by other members, and/or search for content related to a topic or product.

The web application 208 may host the forum 204 and other applications 210. Other applications 210 can be any other web application such as customer account management software or word processing software. Web application 208 facilitates the forum 204 and helps in organizing the questions and answers presented by the user systems 200 and storing the content of the forum 204 in a support help database 212. The support help database 212 may also contain information about solving technical problems that are derived from or generated separately from content supplied by the members.

In an embodiment in the multi-tenant database system 202, the web application 208 sends web pages to the user systems 200 over data communication network(s) 214, receives information from the user systems 200 through information entered into fields of the webpage, and/or receives information generated by a user interacting with the webpage, such as by selecting links. Web application 208 includes one or more instructions that cause a processor to render a webpage. Rendering a webpage may involve performing computations, such as retrieving information.

The data communication network(s) 214 may be any digital or other communications network capable of transmitting messages or data between devices, systems, or components. In certain embodiments, the data communication network(s) 214 includes a packet switched network that facilitates packet-based data communication, addressing, and data routing. The packet switched network could be, for example, a wide area network, the Internet, or the like. In various embodiments, the data communication network(s) 214 includes any number of public or private data connections, links or network connections supporting any number of communications protocols. The data communication network(s) 214 may include the Internet, for example, or any other network based upon TCP/IP or other conventional protocols. In various embodiments, the data communication network(s) 214 could also incorporate wireless and/or wired telephone network, such as a cellular communications network for communicating with mobile phones, personal digital assistants, and/or the like. The data communication network(s) 214 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

In an embodiment, the forum 104 can be part of a forum system that allows users to search the support help database 212 for answers to their technical problems. In this way, the support system 206 assists the users by providing answers to their technical problems.

The support system 206 may more directly provide answers to technical problems by using machine learning models such as a machine learning classifier 216 to identify and label support-like group messages for addressing users' technical problems. In this example, a machine learning classifier 216 automatically points users to solutions that match their problem by providing support-related classifications 218 to the support system 206. The support system 206 uses the classifications 218 to access the correct support help from the support help database 212 to send to the user. This saves manual and possibly imprecise searching by the requesting user as well as the time the other members take in responding to these requests.

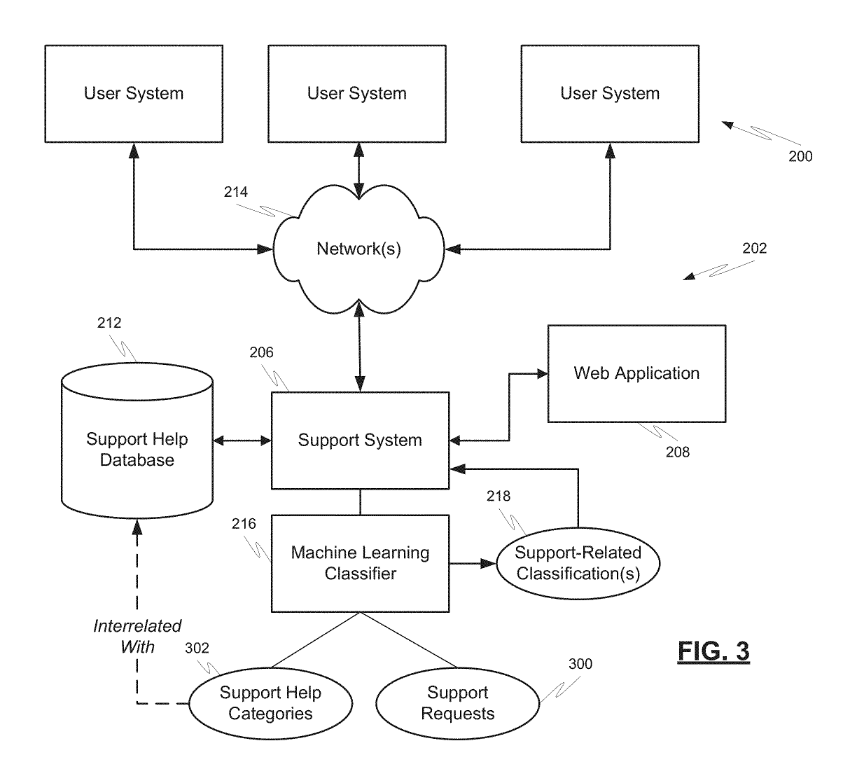

FIG. 3 depicts the machine learning classifier 216 interrelating support requests from the user systems 200 with support help categories in the database 212. More specifically, machine learning classifier 216 reads the natural language of the support request in a post and attempts to put a label on it, such as a help category as shown at 302. Because the support help categories 302 are interrelated with category fields in the support help database 212, the support system 206 can retrieve information from the database 212 that can help the user with the technical problem.

In one embodiment, the machine learning classifier 216 implements a collection of classification and regression algorithms to provide one or more classifications 218. The machine learning classifier 216 maps input values (e.g., support request 300) to labels (e.g., support help categories 302).

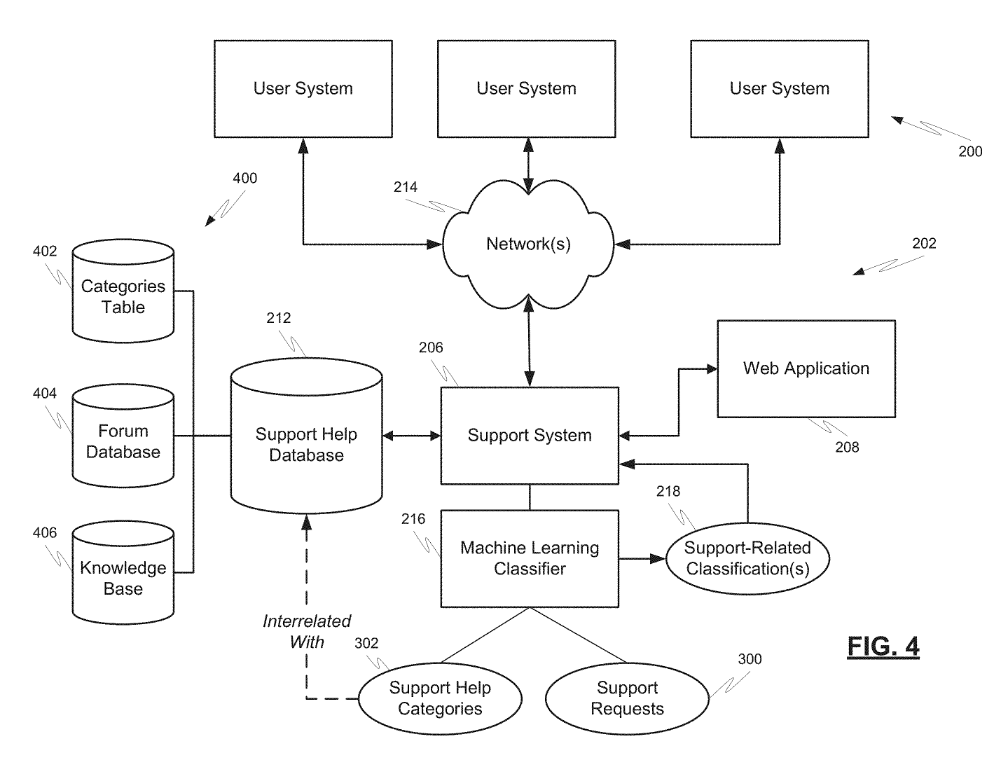

FIG. 4 illustrates at 400 that support help categories associated with the support help database 212 are configurable in many different ways. For examples, support help database 212 can store a categories table 402, forum database 404 and knowledge base 406 among others. The categories table 402 is a table in the support help database 212 that stores a list of categories. The categories can be the support help topic or keywords in articles in the knowledge base and/or the forum conversation or any other category. In an embodiment, the forum database 404 can be a forum conversation that is stored in the support help database 212, and the knowledge base 406 may be a repository of knowledge base articles. Forum conversation and knowledge base articles are classified into categories contained in the categories table 402. A pointer may point to at least a category in the categories table 402 from a forum conversation in the forum database 404. There can be multiple pointers pointing from the forum database 404 to the categories table 402. Similarly, pointers may point to at least a category in the categories table 402 from a knowledge base article in the knowledge base 406. There can be multiple pointers from the knowledge base 406 to the categories table 402.

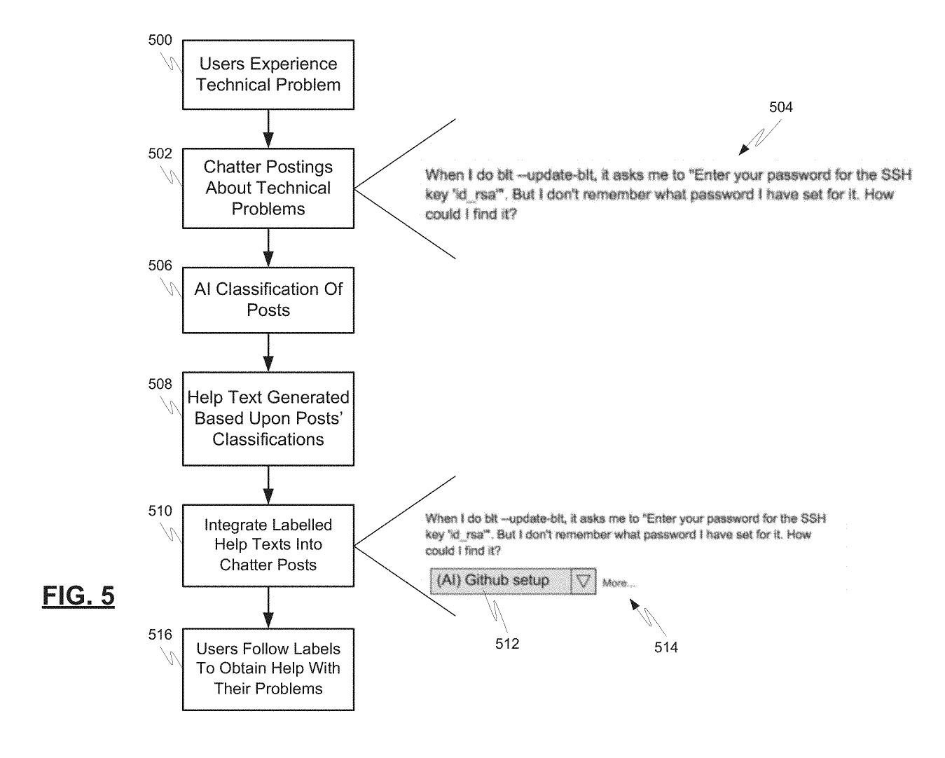

FIG. 5 provides an example of a machine learning classifier mapping support requests to support help categories. At process block 500, users within a forum experience technical problems, such as problems with a software application. The users provide at process block 502 support-based chatter postings about technical problems related to a BLT operation within a GitHub environment. GitHub is a web-based version control repository and Internet hosting service for software development, and BLT is a tool for building, testing, and launching websites.

An example of a technical problem experienced by a user is shown at 504 and relates to locating a forgotten password within the GitHub environment: “When I do blt—update-blt, it asks me to ‘Enter your password for the SSH key ‘id_rsa”. But I do not remember what password I have set for it. How could I find it?’.” An artificial intelligence (AI) classifier (e.g., a machine learning classifier) attempts to classify the post at process block 506. In this example, the AI classifier automatically classifies the forgotten password post to a “Github setup” category based on training.

At process block 508, the support help database is searched using the “Github setup” category as a search term. Based on the search, help text is generated. The help text can take many forms including forum conversation that is retrieved from the database and/or articles from the database. At process block 510, the labeled help text is integrated into a chatter post. In this example, the help text is shown at 512 and is labeled “(AI) Github set up.” If the user clicks the “More . . . ” link at 514, then a rich text help page is displayed at process block 516 and explains how to configure GitHub correctly, such as how to handle passwords within GitHub.

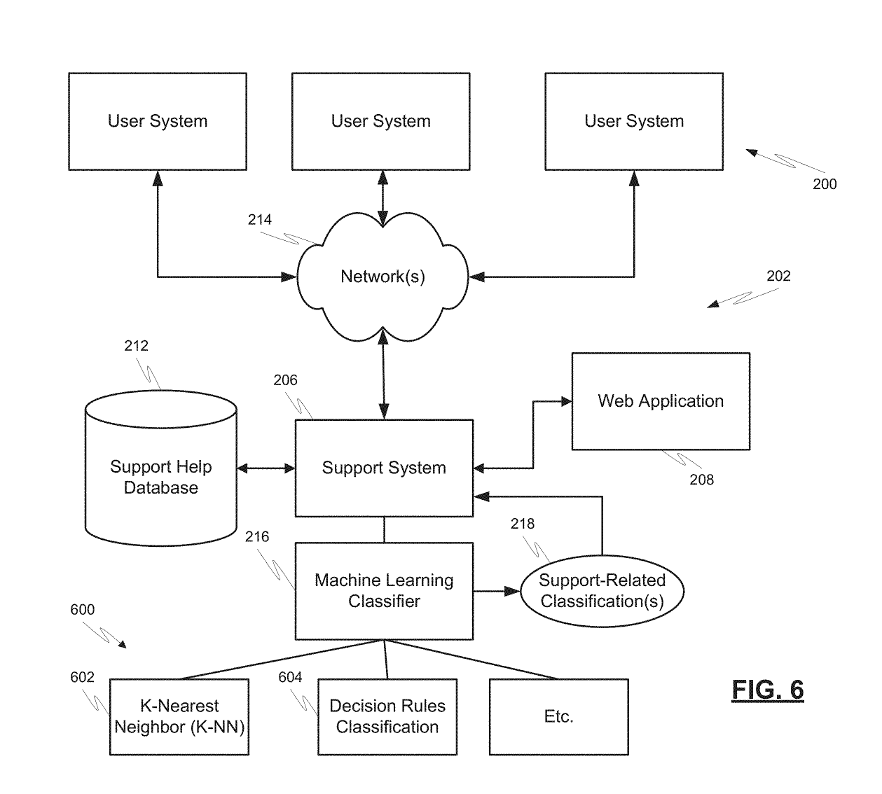

FIG. 6 depicts different machine learning algorithms at 600 for classifying support requests. The machine learning algorithms 600 automatically build classifiers by learning the characteristics of the categories from a set of classified text, and then uses the classifier to classify support requests into predefined categories. The machine learning algorithms 600 can be used separately or together in order to improve the robustness of the classification process.

An example of a machine learning algorithm for classifying support help requests includes the k-nearest neighbor method (k-NN) 602. The k-NN method 602 can be used to test the degree of similarity between terms in a support request and k training data points that are associated with categorization data. More specifically, the k-NN method 602 categorizes data based on the closest feature space in the training set.

The training sets are mapped into multi-dimensional feature space. The feature space is partitioned into regions based on the category of the training set. A point in the feature space is assigned to a particular support category if it is the most frequent category among the k nearest training data. Euclidean distance can then be used to compute the distance between the feature vectors.

The training phase in the k-NN method 602 includes storing support request feature vectors and categories of the training set. In the classification phase, distances from the new vector, representing an input support request, to all stored vectors are computed and the k closest samples are selected. The category of the support request is predicted based on the nearest point that has been assigned to a particular category. If k is equal to one, then the input search request is assigned to the category of that single nearest neighbor.

As another example, a decision rules classification method 604 can be used as the machine learning classifier 216. The decision rule classification method 604 uses rule-based inference to classify support requests to their annotated categories. In this method, a rule set is constructed that describes the profile for each support help category. Rules can be constructed in the format of “IF condition THEN conclusion,” where the condition portion is filled by features of the support help category (e.g., whether the post is GitHub-related, etc.), and the conclusion portion is represented with the support help category's name (e.g., GitHub setup help category) or another rule to be tested. The rule set for a particular category is then constructed by combining every separate rule from the same category with logical operators (e.g., using “and” and “or”). During the classification phase, support help categories can be determined even if not necessarily every rule in the rule set is satisfied. The decision rules classification method 604 may also use for classification operations a local dictionary for each individual category. Local dictionaries are able to distinguish the meaning of a particular word for different categories.

It should be understood that other types of machine learning methods can be used for categorizing support requests. For example, these may include Bayesian classifiers, neural networks, decision trees, Support Vector Machines (SVMs), Latent Semantic Analysis, etc.

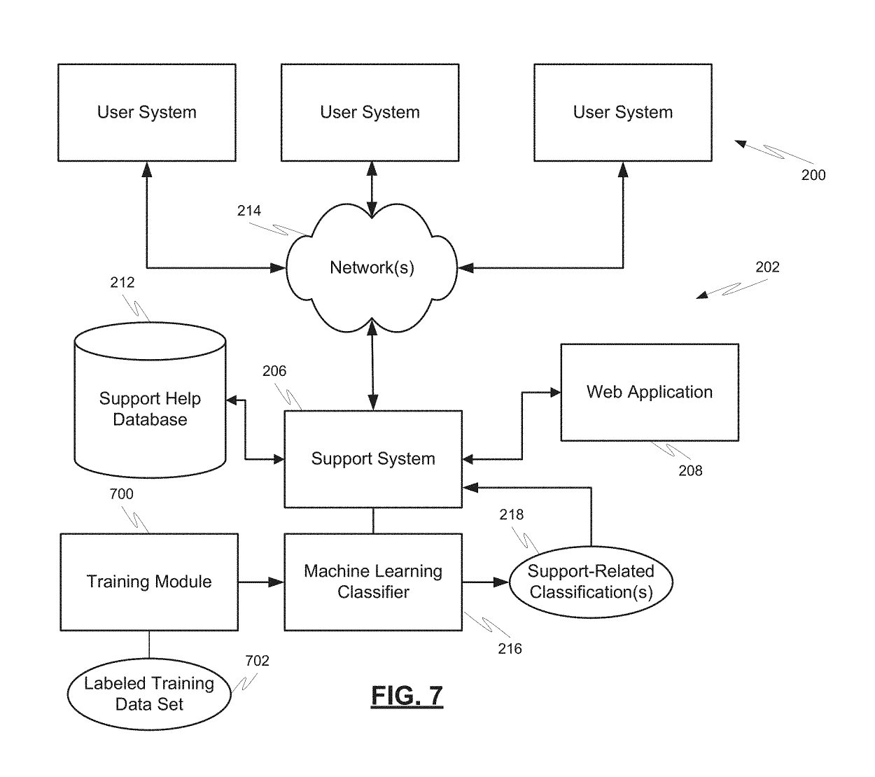

FIG. 7 depicts a training module 700 for training the machine learning classifier 216 and then improving the machine learning classifier 216 post-deployment. The model used by the machine learning classifier 216 is built on training data 702 which contains support request features already associated with support help categories. During training, the training module 700 constructs a model that can predict the categories based on the features. Because the interrelationship between the support request features and categories are pre-defined, the training module 700 can adapt the model's predictions to match the pre-defined associations between the categories and the features. Once the model has been trained, the machine learning classifier 216 can predict categories based on the data points for which the input features are known, but not the category.

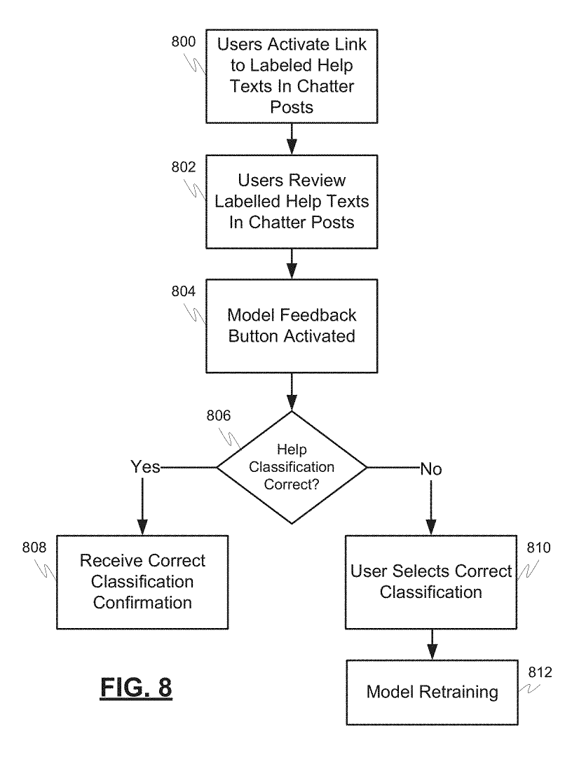

FIG. 8 depicts an operational flow where input from the user systems can retrain the machine learning models based upon labeling attempts by a machine learning classifier. In this operational scenario, users can activate at process block 800 a link to labeled help texts in a post. At process block 802, users review the labeled help texts in posts. For example, users may review the help text associated with the GitHub password configuration problem.

At process block 804, the webpage containing the help text has a feedback button that allows the user to indicate whether the machine learning classifier has provided the correct category. If the user indicates that the support help classification is correct at decision block 806, then the support system receives a confirmation of the correct classification at process block 808.

If the help classification is not correct, however, then processing continues at process block 810 where the user provides the correct classification. The correct classification is then used for retraining the model of the machine learning classifier at process block 812. As shown by this approach, model training is enhanced because of the unique environment of groups that are support-like in nature. The operational scenario shows that such environments allow the work of classifying to leverage crowdsourcing to improve model training.

It should be understood that the operations of the operational scenario can be configured in different ways. For example, additional processing of user category recommendations may be performed to allow multiple recommendations to be submitted. In such a situation, users can be provided with a webpage that contains links to participate in a forum by reading a posted question, replying, escalating a question, promoting an answer to the knowledge base, and voting. In an embodiment, the original requesting user may indicate that the user likes the classification by choosing the like link. Authorized personnel can vote a reply to be the best answer by choosing the best answer link. Other privileges of authorized personnel may include editing the reply by choosing the edit link and deleting the reply by choosing the delete link. Authorized personnel may also promote a recommendation for use in the machine learning training data set.

As another example, when a user confirms that a solution works, the post can remove the artificial intelligence (AI) label to show this as a confirmed classification. Such a label is shown at 512 on FIG. 5. A similar type of operation can be performed if a user classifies the post by selecting a label from a picklist.

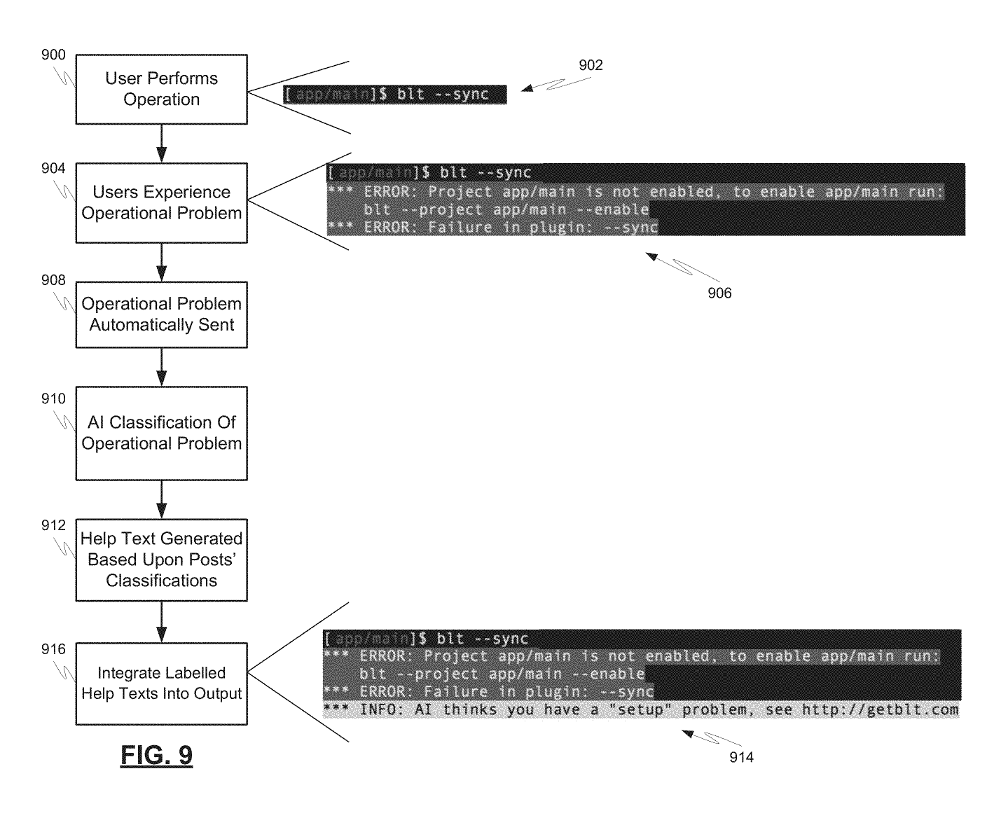

FIG. 9 depicts an operational scenario where technical support is automatically provided to users experiencing technical problems in executing a software operation. At process block 900, a user or a computer program performs an operation. For example, the user has entered the following command “$ blt—sync” as shown at 902. An operational problem occurs at process block 904 in response to execution of the command as shown at 906. The machine learning classifier performs an AI classification of the operational problem at process block 910. This allows the machine learning classifier to be used directly on the output from failing commands and is not from a user post.

Help text is generated based upon the classification at process block 912 and is provided as output 914 at process block 916. It should be understood that the last information line shown in output 916 is the result of looking up the output from the failing command and classifying it as “setup.” Additionally, a link could be generated for the user that points to the proper help page. Still further, the machine learning classifier can be tied in with runtime and compile errors to automatically provide help for such errors.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to object models, web pages, multi-tenancy, cloud computing, on-demand applications, and other functional aspects of the systems (and the individual operating components of the systems) may not be described in detail herein. In addition, those of ordinary skill in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first,” “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another. In one or more exemplary embodiments, the subject matter described herein is implemented in conjunction with a virtual customer relationship management (CRM) application in a multi-tenant environment.

While at least one exemplary embodiment has been presented, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed:

1. A processor-implemented method for generating help in response to messages from users in a support-related group, said method comprising:
receiving, by one or more data processors, a support-related message that is from a user in the support-related group and contains a support-related problem;
classifying, by the one or more data processors, the received support-related message by using a processor-implemented machine learning model to identify a first support-related category, the machine learning model containing categories associated with technical problems resulting from utilization by the users of a pre-selected product or service;
providing, by the one or more data processors, for user display the identified first support-related category;
receiving, by the one or more data processors, a second support-related category as a correction to the identified first support-related category;
retraining, by the one or more data processors, the machine learning model based upon the received second support-related category, the retrained machine learning model operating as an improvement in identifying supported-related categories for the technical problems associated with the users in the support-related group; and
automatically retrieving, by the one or more data processors, support information for at least one of the users based upon the retrained machine learning model in response to an error message arising within a software application.

2. The method of claim 1 further comprising:
storing content related to the pre-selected product or service in a support help database, the content including communications from the support-related group and knowledge base articles, the content being associated with the first and second support-related categories and with other support-related categories.

3. The method of claim 2 further comprising:
retrieving the content from the support help database that is associated with the first support-related category; and
providing for the user display the retrieved content that is associated with the first support-related category.

4. The method of claim 1, the first support-related category and the second support-related being support help topics or keywords from articles in a knowledge base or a forum conversation.

5. The method of claim 1, the pre-selected product or service being related to a software application.

6. The method of claim 1 further comprising:
integrating the first and second support-related categories into chatter posts for display on the user display.

7. The method of claim 6 further comprising:
receiving activation of a link associated with one of the chatter posts; and
providing support help text to the user display in response to the activation of the link, the support help text being directed to solving the support-related problem.

8. The method of claim 1, the classifiers of the machine learning model being generated based upon learning characteristics of categories from a set of classified text.

9. The method of claim 8, the classifiers of the machine learning model being determined based upon a k-nearest neighbor model which tests degree of similarity between terms in the support-related message and training data points that are associated with the first and second support-related categories.

10. The method of claim 8 further comprising:
receiving output from a failing software command that is not from a chatter post, the classifiers of the machine learning model being used to provide help text for user display in response to the output from the failing command.

11. A database system comprising a hardware processor and non-transient computer readable media coupled to the processor for generating help in response to messages from users in a support-related group, the non-transient computer readable media comprising instructions configurable to be executed by the processor to cause the database system to:
receive a support-related message that is from a user in the support-related group and contains a support-related problem;
classify the received support-related message by using a processor-implemented machine learning model to identify a first support-related category, the machine learning model containing categories associated with technical problems resulting from utilization by the users of a pre-selected product or service;
provide for user display the identified first support-related category;
receive a second support-related category as a correction to the identified first support-related category;
retrain the machine learning model based upon the received second support-related category, the retrained machine learning model operating as an improvement in identifying supported-related categories for the technical problems associated with the users in the support-related group; and
automatically retrieve support information for at least one of the users based upon the retrained machine learning model in response to an error message arising within a software application.

12. The system of claim 11, wherein content is stored related to the pre-selected product or service in a support help database, the content including communications from the support-related group and knowledge base articles, the content being associated with the first and second support-related categories and with other support-related categories.

13. The system of claim 12, wherein the content is retrieved from the support help database that is associated with the first support-related category;
wherein the retrieved content that is associated with the first support-related category is provided for the user display.

14. The system of claim 11, the first support-related category and the second support-related being support help topics or keywords from articles in a knowledge base or a forum conversation.

15. The system of claim 11, the pre-selected product or service being related to a software application.

16. The system of claim 11, wherein the first and second support-related categories are integrated into chatter posts for display on the user display.

17. The system of claim 16, wherein activation of a link associated with one of the chatter posts is received by the database system;
wherein support help text is provided to the user display in response to the activation of the link, the support help text being directed to solving the support-related problem.

18. The system of claim 11, the classifiers of the machine learning model being generated based upon learning characteristics of categories from a set of classified text, the classifiers of the machine learning model being determined based upon a k-nearest neighbor model which tests degree of similarity between terms in the support-related message and training data points that are associated with the first and second support-related categories.

19. The system of claim 18, wherein output from a failing software command is received that is not from a chatter post, the classifiers of the machine learning model being used to provide help text for user display in response to the output from the failing command.

20. A non-transient computer readable storage media comprising computer instructions configurable to be executed by a hardware processor in a database system to cause the database system to:
receive a support-related message that is from a user in a support-related group and contains a support-related problem;
classify the received support-related message by using a processor-implemented machine learning model to identify a first support-related category, the machine learning model containing categories associated with technical problems resulting from utilization by the users of a pre-selected product or service;
provide for user display the identified first support-related category;
receive a second support-related category as a correction to the identified first support-related category;
retrain the machine learning model based upon the received second support-related category, the retrained machine learning model operating as an improvement in identifying supported-related categories for the technical problems associated with the users in the support-related group; and
automatically retrieve support information for at least one of the users based upon the retrained machine learning model in response to an error message arising within a software application.
